(19) United States
(12) Patent Application Publication
(10) Pub. No.: US 2025/0256580 A1
(43) Pub. Date: Aug. 14, 2025

(54) INTEGRATED AND NON-INTEGRATED POWERBANK ASSEMBLY FOR VEHICLES

(71) Applicant: NEEDZAPPY, INC., FORT LAUDERDALE, FL (US)

(72) Inventor: Ryan Paul DAVIDSON, Key Biscayne, FL (US)

(21) Appl. No.: 19/051,695

(22) Filed: Feb. 12, 2025

Related U.S. Application Data
(60) Provisional application No. 63/552,254, filed on Feb. 12, 2024.

(51) Int. Cl. B60L 1/00; B60R 11/00; H01M 10/42; H01M 10/48; H01M 50/247; H01M 50/249; H01M 50/262; H02J 7/00

(52) U.S. Cl. CPC B60L 1/006; H01M 10/4257; H01M 10/488; H01M 50/247; H01M 50/262; H02J 7/00034; H02J 7/0044; H02J 7/0047; B60R 11/00; B60R 2011/0015; B60R 2011/0017; H01M 2010/4278; H01M 50/249; H01M 2220/20; H01M 2220/30

(57) ABSTRACT

An integrated powerbank assembly that can be built into a vehicle's interior. The integrated powerbank assembly generally comprises a portable unit with an interior battery as well as a charging assembly that is built into the vehicle. The charging assembly comprises a receptacle configured to receive and lock the portable power unit for charging. The charging assembly can be installed in various vehicle locations like the dashboard, center console, glove compartment or armrest storage. The charging assembly may be operatively connected to the vehicle's battery and/or electrical system to control and monitor charging of the battery of the power unit. Additionally, the charging assembly and/or receptacle may be operatively configured with a dispensing mechanism that allows a user to selectively place the power unit into and out of a “locked position”, which is intended for charging, and an “unlocked position” which is intended for use as a portable powerbank.

### CROSS-REFERENCE TO RELATED APPLICATIONS

This application claims the benefit of U.S. provisional application No. 63/552,254 filed Feb. 12, 2024, which is hereby incorporated herein in its entirety by reference.

### FIELD OF INVENTION

The present invention relates to portable powerbanks.

### BACKGROUND

Portable power sources have become increasingly popular in recent times as mobile devices with rechargeable batteries have become widespread. Such portable power sources may be associated with devices such as smartphones, tablets, smartwatches, wireless headphones, and others. However, there are various drawbacks associated with portable power sources. For example, users must remember to charge portable power sources and often they must also remember to carry various associated components such as cables, chargers, adapters, etc. This can be inconvenient and impractical. In addition, while some mobile device cases have integrated battery packs, they also have important limitations as they are generally designed to work with only one specific device model or type. Additionally, electric vehicles have also become widespread in recent times, including due of government incentives and subsidies that are aimed to promote transportation that may reduce carbon emissions. While electric vehicles incorporate large battery packs to power an electric motor, unlike gas-powered vehicles, electric vehicles cannot simply be replenished quickly. This is particularly relevant if the electric vehicle runs low on charge and/or range. As such, electric vehicle drivers must identify and travel to a charging station to recharge not only their electric vehicle, but if needed their portable power source. Thus, this inconvenience is also associated with a time loss, not only of driving time, but also the time the user needs to dedicate to charging. Accordingly, there is a need in the industry to provide for a solution that addresses the foregoing drawbacks.

Integrating portable and/or removable power bank charging and storage capabilities directly into vehicles could provide an improvement over portability and accessibility issues associated with portable power sources. This could provide a convenient way for vehicle occupants to charge multiple portable devices without any additional equipment or components. This could also offer a unique opportunity to utilize the vehicle's energy, including the excess energy of an electric, hybrid or conventional vehicle for powering portable powerbanks. An even further benefit would be realized in the industry by providing an integrated or non-integrated powerbank solution that would promote sustainability and would reduce the need for constant replacement of components. Yet a further solution would be realized by providing a solution that would allow users to achieve an enhanced user experience via a powerbank manufactured for use with specific vehicle types and/or specific manufacturers. Such a solution has the potential to enable partnerships with the manufacturers, which would enable them to integrate and distribute branded powerbank into their vehicles. In turn, such a solution would also have the potential to enhance the manufacturer's market position. Selling or renting portable power units that can be used with a vehicle's charging assembly would also offer a potential business model opportunity. For example, manufacturers could sell additional or replacement powerbanks post sale, thereby creating a continuous revenue stream beyond the initial vehicle purchase.

### SUMMARY

The present invention is directed to an integrated powerbank assembly that can be built into a vehicle's interior during manufacturing or installed afterwards. The inventive integrated powerbank assembly generally comprises a portable powerbank, also referred herein as a portable unit. The powerbank assembly also comprises a charging assembly that is built into a component of the vehicle. The powerbank assembly further comprises a receptacle, which is also built into a component of the vehicle, and which is configured to receive the portable power unit. The portable power unit comprises a housing that can be inserted into the receptacle where it is held in place and charged. This allows an internal rechargeable battery of the portable unit to be continuously charged while it is inserted into the receptacle. The charging assembly can be installed in various vehicle locations, including the dashboard, center console, glove compartment or armrest storage. Furthermore, the charging assembly may be operatively connected to the vehicle's battery and/or electrical system to control and/or monitor charging of the battery of the power unit. Additionally, the charging assembly and/or receptacle may be operatively configured with a dispensing mechanism that allows a user to selectively place the power unit into and out of a “locked position”, i.e., which is intended for charging. As such, a user may selectively insert and/or remove a power unit form the charging assembly as needed and take it outside of the vehicle for use as a power source.

The present invention is also directed to a non-integrated powerbank assembly that can be removably attached to a vehicle component, e.g., a headrest or seat, allowing charging of one or more power units as described herein. This can be useful for ride sharing vehicles or applications. The non-integrated powerbank assembly generally comprises a casing with a receptacle(s) where a power unit(s) may be inserted for charging. The non-integrated powerbank assembly generally comprises an internal battery, charging ports, and/or a dispenser to lock/unlock inserted power units. There is also an outside charging port to recharge the internal battery. Additionally, the non-integrated powerbank assembly may be provided with an adjacently disposed touch screen. The screen may be operatively configured to run an application allowing users to purchase and/or rent power units and/or charging time.

### BRIEF DESCRIPTION OF THE DRAWINGS

FIG. 1 is a front perspective view of one embodiment of the integrated powerbank assembly according to the present invention.

FIG. 2 is a front perspective view of another embodiment of the integrated powerbank assembly according to the present invention.

FIG. 3 is a front perspective view of a further embodiment of the integrated powerbank assembly according to the present invention.

FIG. 4 is a front perspective view of yet another embodiment of the integrated powerbank assembly according to the present invention.

FIG. 5 is a front perspective view of an even further embodiment of the integrated powerbank assembly according to the present invention.

FIG. 6 is a front perspective view of another embodiment of the integrated powerbank assembly according to the present invention.

FIG. 7 is a perspective view of one embodiment of a portable unit according to the present invention disposed on a mobile device case.

FIG. 8 is a perspective view of one embodiment of a mobile device case with a power unit disposed thereon according to the present invention.

FIG. 9 is a perspective view of one embodiment of a non-integrated powerbank assembly according to the present invention.

FIG. 10 is a perspective view of another embodiment of a non-integrated powerbank assembly according to the present invention.

FIG. 11 is a perspective view of yet another embodiment of a non-integrated powerbank assembly according to the present invention.

FIG. 12 is a schematic representation of one embodiment of an integrated power bank assembly according to the present invention.

FIG. 13 is a schematic representation of one embodiment of a charging station of the integrated power bank assembly according to the present invention.

### DETAILED DESCRIPTION

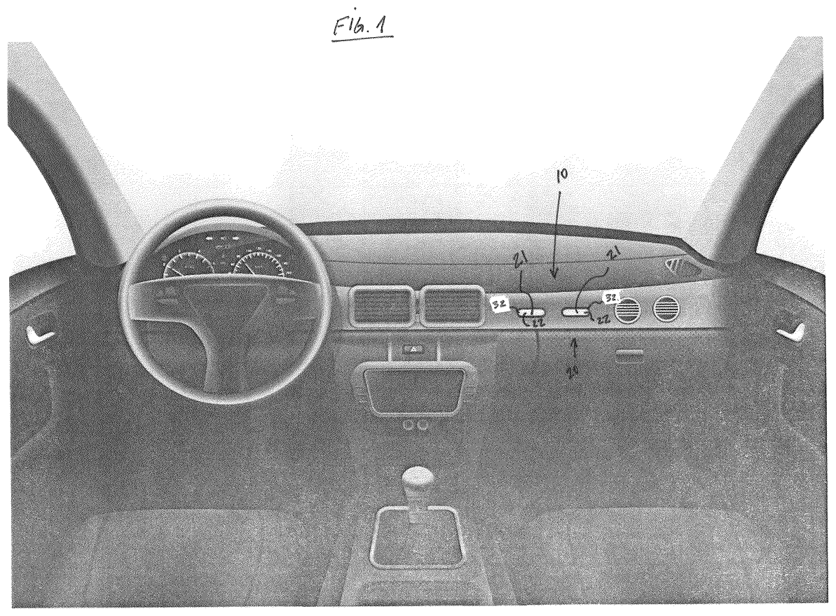

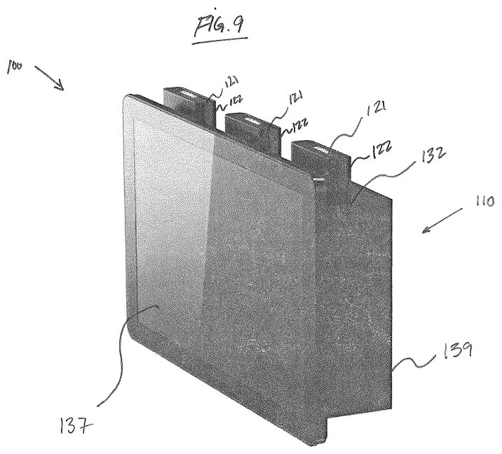

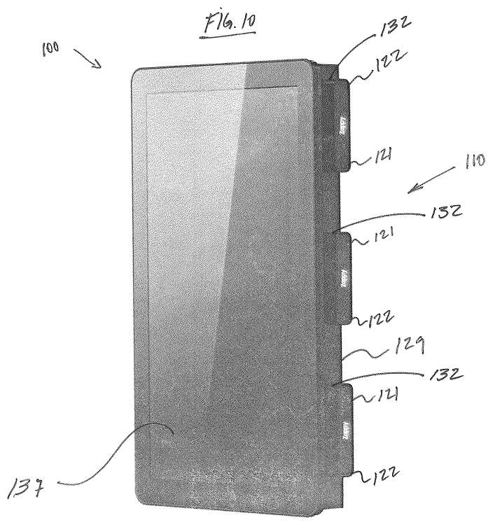

With initial reference to FIGS. 1-8 and 12-13, the present invention is directed to an integrated portable powerbank assembly 10. With reference to FIGS. 9-11, the present invention is also directed to a non-integrated powerbank assembly 100. The integrated powerbank assembly 10 according to the present invention is generally intended for use in connection with vehicles, boats, airplanes and/or other related transportation apparatuses. The integrated powerbank assembly 10 may be built into, installed, formed, constructed, or otherwise incorporated into an interior component of the vehicle. Conversely, the non-integrated powerbank assembly 100 may also be used in connection with a vehicle, boat, or another transportation machinery, but it is contemplated that a portable unit of the non-integrated powerbank assembly 100 may be removable in its entirety from the vehicle, boat, etc. As used herein, the term “vehicle” refers to a motor vehicle, bicycle, motorcycle, boat, train or other related transportation equipment or machinery where the inventive integrated powerbank assembly 10 may be installed, formed, etc., and/or where the inventive non-integrated powerbank assembly 100 may be temporarily or removable disposed.

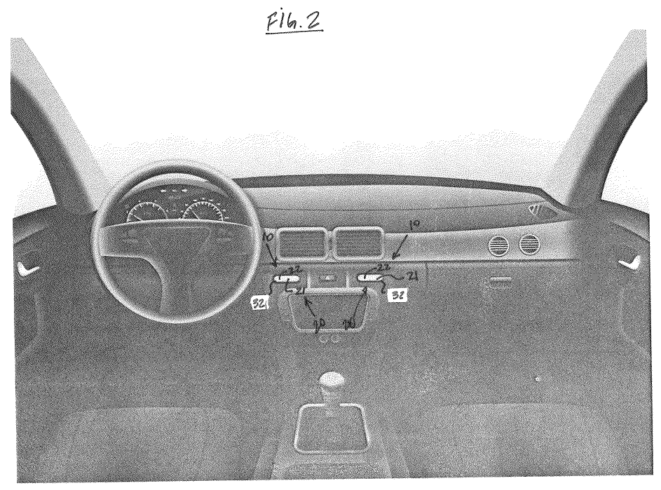

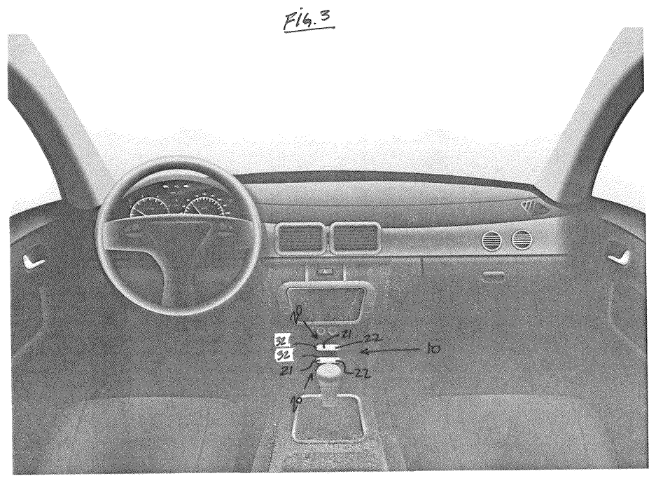

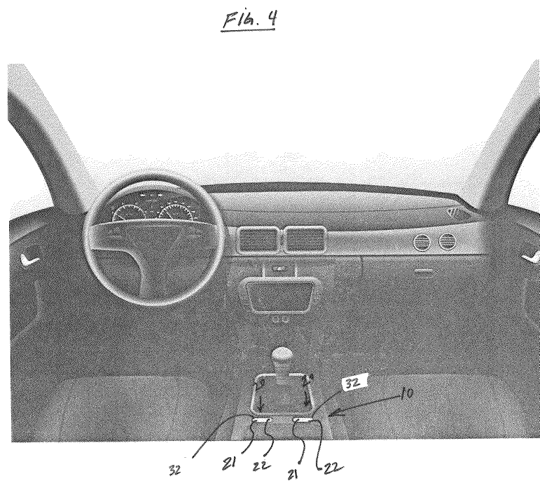

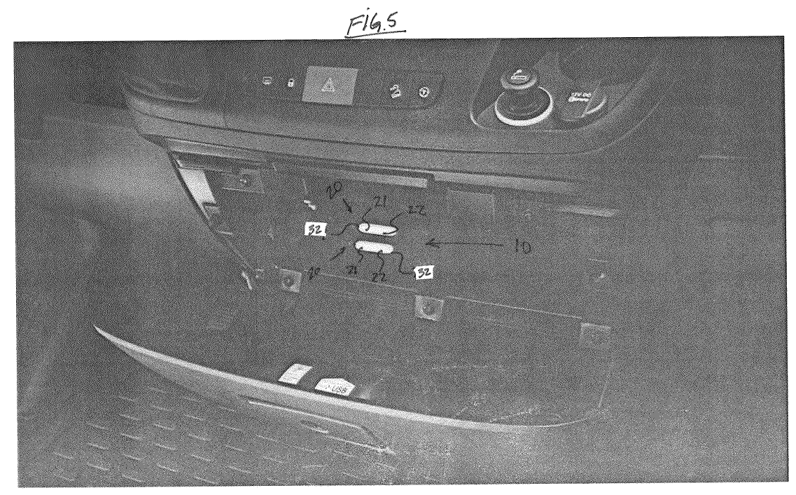

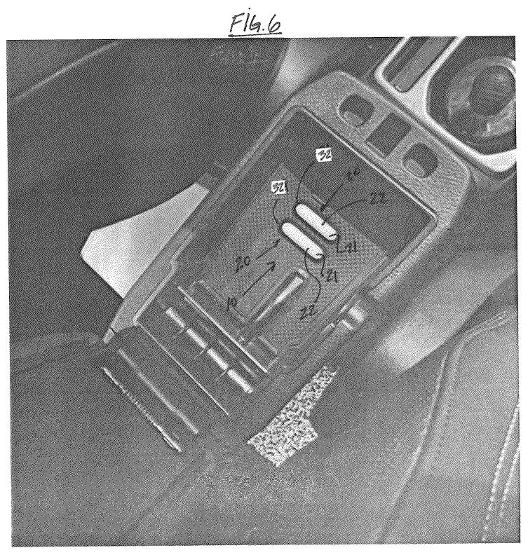

The present invention contemplates that both the integrated powerbank assembly 10 and the non-integrated powerbank assembly 100 may be configured for storing and/or charging individual portable power units. For example, as is represented in FIGS. 1-6, the inventive integrated powerbank assembly 10 may be provided with a portable powerbank, which is indicated at 20. The portable powerbank 20 may comprise a portable power unit 21 or simply portable unit and may also comprise a cooperatively configured mobile device case 26. The portable unit 21 is intended to be inserted into a receptacle 32 of a charging assembly 30. The charging assembly 30 and/or receptacle 32 thereof may be operatively disposed onto a component of the vehicle. That is, the charging assembly 30 and/or receptacle 32 may be built into, or otherwise formed into, a component of the vehicle during the manufacturing process and/or may be installed thereafter. For example, the charging assembly 30 may be disposed on a section of the dashboard of the vehicle, e.g., as shown in FIG. 1, or adjacent to a navigation screen and/or vents of the vehicle, e.g., as shown in FIG. 2, or below the navigation screen, e.g., as shown in FIG. 3, or even adjacent to the gear selector of the vehicle, e.g., as shown in FIG. 4. Alternatively, the charging assembly 30 and/or receptacle 32 may be disposed on an inside of a glove compartment or other compartment of the vehicle, e.g., as shown in FIG. 5, or within a compartment below the armrest of the driver/co-pilot of the vehicle, e.g., as shown in FIG. 6.

As shown in at least in FIGS. 1-6, the power unit 21 may comprise a housing 22 where its operative components may be stored. Such operative components, may include, without limitation, an in-built rechargeable battery, a microprocessor, communication ports, etc. Accordingly, the power unit(s) 21 is configured to be disposed in a “charging position” while it is inserted into the receptacle 32 of a charging assembly, e.g., as shown throughout the illustrative embodiments of FIGS. 1-6. Thus, it is within the scope of the present invention that a charging assembly should be configured to deliver a substantially continuous charge to the power unit(s) 21, e.g., via an internal rechargeable battery thereof while the charging unit remains inserted into the receptacle 32.

Further features of the present invention allow for a selective charging of the internal battery of the power unit 21. For example, charging of the internal battery of the power unit 21 may occur while the vehicle is in operation. As a further example, and as it relates to electric vehicles, charging of the internal battery of the power unit 21 may occur while the vehicle itself is being charged. Such selective charging of the internal battery of the power unit 21 may also involve periods of non-operation, for example, the internal battery should be configured to stop charging—of the power unit 21—to prevent depletion of the charge of the battery of the vehicle below an operational threshold or another predetermined threshold. Additional features of the present invention may also allow for selective charging of the internal battery of the power unit 21 to optimize charging thereof.

The present invention contemplates providing a charging assembly 30 installed or otherwise disposed on the vehicle, including permanently. For example, as it relates to the illustrative embodiments of FIGS. 1-6, the charging assembly may be disposed on an intended area of the vehicle. For example, the charging assembly may be disposed inside of the dashboard (FIG. 1), inside of the front panel (FIGS. 2-3), inside of the center console (FIG. 4), inside of the glove compartment (FIG. 5), or below the armrest compartment (FIG. 6).

The present invention further contemplates that the charging assembly 30 be provided with an integrated dispenser, including during manufacturing. That is, the receptacle 32 of the charging assembly 30 may be configured and dimensioned to not only receive a housing 22 of the portable unit 21, but also to selectively secure it in place, for example, upon a user pushing the housing 22 into the receptacle 32. As a further example, the receptacle 32 may also be configured to allow for the user selectively release the housing 22 of the portable unit 21, for example, by pushing the housing 22 into the receptacle a second time. As such, the receptacle 32 and/or other components of the charging unit may be provided with a spring mechanism configured to allow the user to selectively position the housing 22 inside of the receptacle and into and out of a “locked position” or “charging position” and an “unlocked position” or “release position”. Thus, it is contemplated that the charging assembly will replenish the charge of the battery of the portable unit 21 while the housing 22 is disposed into the locked or charging position.

The charging assembly 30 may further comprise a charging port(s) disposed within the receptacle 32. The charging ports may be cooperatively configured with the portable unit 21 to enable a mating engagement therebetween, including to initiate and/or maintain charging of the portable unit 21. As such, the portable unit 21 may also be provided with a charging port(s) cooperatively configured with the charging port(s) of the charging assembly. Thus, a mating engagement may be enabled between the charging port(s), respectively of the portable unit 21 and the charging assembly, including internal components thereof.

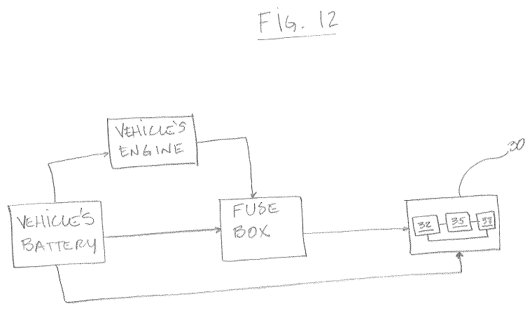

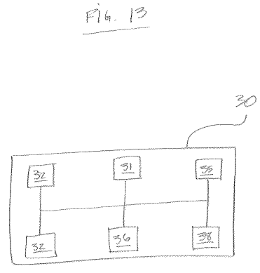

Additionally, and with reference to at least the illustrative embodiment of FIGS. 12-13, the charging assembly 30 may be operatively connected to the battery system of the vehicle. With reference to at least FIG. 13, the charging assembly 30 may comprise internal components, including without limitation, an internal battery 31, a processor 35, microprocessor 36, controller 38, or other related components to control the charge being provided to the portable unit 21. Such processor 35, microprocessor 46 and/or controller 38 should also be configured to ascertain when the portable unit 21 is disposed in and/or removed from the receptacle 32 of the charging assembly. As is also shown at least in the illustrative embodiment of FIG. 12, the charging assembly 30 may comprise an internal rechargeable battery 31, i.e., operatively configured with the battery system of the vehicle. As such, the present invention further contemplates that the inventive portable unit 21 be reusable. For example, a user may charge the portable unit 21 while in the vehicle and take outside of the vehicle for use as a power source for other devices, and later return it to its charging position within the vehicle. As such, this feature may promote sustainability and may contribute to reducing reduces the need for constant replacement of portable units 21.

With reference to FIGS. 9-11, and as briefly mentioned above, the present invention is also directed to a non-integrated powerbank assembly 100. A non-integrated powerbank assembly 100 may be advantageous for situations where it may not be feasible to manufacture the underlying vehicle with an integrated powerbank assembly 10 or for vehicles previously manufactured without one. As such, it may be practical and/or beneficial to provide a non-integrated powerbank assembly 100 that may be attached to a component of the vehicle, for example, the backside of a headrest or seat of the vehicle. A non-integrated powerbank assembly 100 may also be useful for ridesharing and/or taxis, shuttles, buses, trains, etc., where individual users may want to acquire individual portable units 21/121 as described herein. Additionally, it may also be desirable to provide a non-integrated powerbank assembly 100 that may allow users to either charge their own portable units 21/121 or simply use the non-integrated powerbank assembly 100 to charge them.

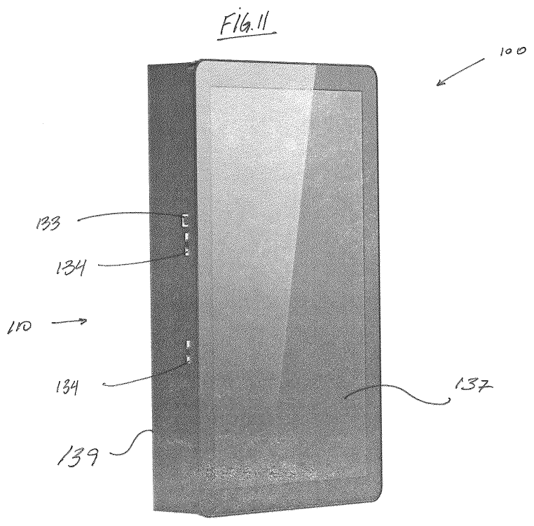

Accordingly, and as shown in FIGS. 9-11, a non-integrated powerbank assembly 100 generally comprises a powerbank station 110 that can store and/or recharge individual power units 121 but may also comprise a screen 137. The powerbank station 110 may similarly comprise a charging unit 150 disposed on an inside of a casing 139. The casing 139 may comprise a variety of shapes and/or dimensions but should be configured and dimensioned for an at least partial insertion of one or more housings 122 of individual portable units 121 and including in a spaced apart relation between them. Said differently, the casing 139 may comprise a receptacle 132 configured and dimensioned for an at least partial insertion of an individual housing 122 of the portable unit(s) 121. The charging assembly may further comprise a plurality of individual operative components that may enable the charging of the portable unit(s) 121, which may include, without limitation, an integrated battery system, charging ports configured to charge the portable unit(s) 121, a dispenser as described herein, e.g., with a spring mechanism configured to lock/unlock the housing 122 of the portable unit(s) 121. The charging assembly may also comprise other components such as a processor or microprocessor operatively configured with memory storage, an outside charging port 133 and/or exterior communication ports 134, e.g., as shown in FIG. 11. Such communicating ports 134 may further comprise, lightning charging, USB-C, micro-USB and/or wireless capabilities. As such, the battery of the charging assembly of the powerbank station 110 may be replenished by connecting outside charging port 133 to an outside charging source.

As also shown in FIGS. 9-11, the non-integrated powerbank assembly 100 may further comprise a screen 137 adjacently disposed to the casing 139. The screen 137 may comprise a touch screen and may be operatively configured with other components, e.g., processor, microprocessor, memory storage. As such, executable instructions and/or executable computer code may be operatively stored within the memory storage and may be configured with the processor to run a program or application on the screen 137 of the powerbank station 110. The screen 137 may be operatively configured with the memory storage and/or processor or microprocessor to visually implement or otherwise reproduce the program or application. As such, the screen 137 may be configured to display to the user a variety of programs or options, inducing for entertainment or promotions, and/or configured to allow the user to make predetermined selections associated with a purchase/rental of a portable unit 21/121.

Therefore, it is contemplated that a user may purchase or otherwise acquire a portable unit 21/121 through the touch screen 137. However, a user may also use the touch screen 137 to acquire charging time, which may involve manually inserting a previously acquired portable unit 21/121 into a receptacle 132 of the powerbank station 110 or swapping a previously acquired portable unit 21/121 for a new one in exchange for a predetermined payment amount. Moreover, the screen 137 may be operatively configured the processor and/or memory, enable various forms of payment, including through a user account, credit card, and/or other payment options. Alternatively, a previously acquired portable unit 21/121 may be automatically associated with a user account comprising previously entered user data. Thus, a user may also be given the ability to login, e.g., through an authentication protocol associated with a mobile device or by scanning an authentication code, such that the user may take a portable unit 121 from the powerbank station 110 and/or may swap a previously acquired portable unit 21/121 for a new one, or may simply insert a previously acquired portable unit 21/121 from an existing open receptacle 132.

Even additional features of the present invention comprise providing a customized delivery options of a portable power unit 21/121. For example, the present invention contemplates that a non-integrated powerbank assembly 100 may be placed on a vehicle, e.g., on the back of a seat or on the back of a headrest, and that users may be able to use it to purchase and/or replenish the charge of a portable power unit 21/121. Such vehicles may include, without limitation rideshare vehicles, taxis, or even private vehicles. Accordingly, the present invention further contemplates that the driver of such vehicles with at least one non-integrated powerbank assembly 100 disposed thereon may have the option to act as a portable power unit 21/121 delivery driver if a customer that is not in the vehicle may place an order for the delivery of a portable power unit 21/121. Said differently, such vehicles may also act as a delivery vehicle, that if located within sufficient proximity, and if carrying a sufficient inventory of suitable portable power units 21/121, i.e., new or replenished, can fulfil a delivery request. Such a delivery request may involve the purchase, rental or swapping of a portable power unit(s) 21/121.

As such, the present invention contemplates that a customer may access and place an order via an electronic platform platform, e.g., via a mobile application downloadable onto a mobile device or via a web browser accessible from a desktop, laptop, mobile device, etc., for the rental, purchase or swapping of a portable power unit(s) 21/121. A corresponding pairing protocol may be implemented, e.g., by a computer program and/or executable instructions operatively configured with the mobile device, a processor, a data network and/or a server. Such a pairing protocol may be configured to ascertain a current request for the delivery of a portable power unit 21/121 and may match or otherwise pair that request to the closest delivery vehicle, e.g., within a predetermined range and/or with a sufficient inventory of a portable power unit(s) 21/121. Accordingly, the present invention further contemplates that both the driver and the customer may use a device, i.e., mobile device, laptop, desktop, etc., that is operatively configured with a data network and/or service, including to enable data transmission between devices and to enable a pairing as described herein. Such devices may be cooperatively configured with a computer program and/or other applications to allow for real time location tracking of a specific order.

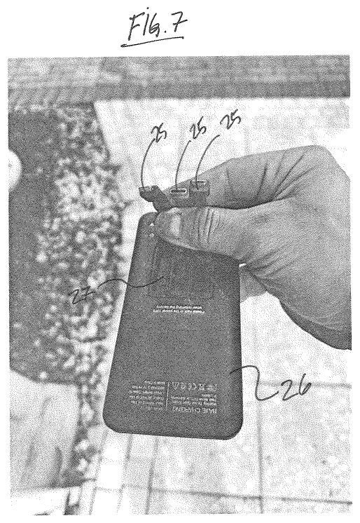

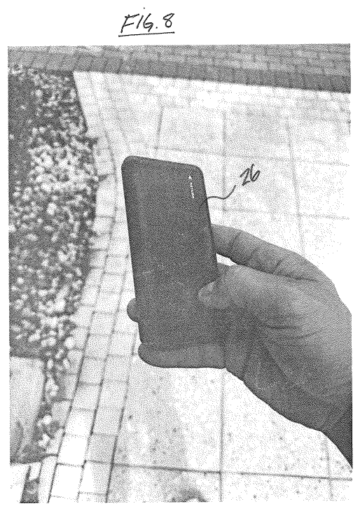

With specific reference to FIGS. 7-8, additional features of the present invention comprise providing an integrated powerbank assembly 10 and/or a non-integrated powerbank assembly operatively configured with a mobile device case 26. That is, an individual portable unit(s) 21 and/or 121 may be operatively configured for insertion onto a mobile device case, e.g., onto a reverse side as shown in FIG. 7. Further, it is contemplated that the individual components of the portable unit 21/121 may be stored within a housing 22/122 and that the housing may be configured for insertion into, and/or removal from, a socket 27 of the mobile device case 26. As such, and as may be appreciated form FIG. 8, when the portable unit 21/121 is inserted into the receptacle 132 it should be substantially concealed or otherwise indiscernible. As shown in FIG. 7, the portable unit 21/121 may also be provided with various connections 125 and/or communication cables, i.e., lightning charging, USB-C, micro-USB and/or wireless capabilities. Moreover, it is contemplated other internal components of the portable unit 21/121 also be concealed, including without limitation, its rechargeable battery, microprocessor, memory storage, charging connections, etc.

Even additional features of the present invention include various user selectable options associated with an integrated powerbank assembly 10 and/or a non-integrated powerbank station 110. For example, the present invention contemplates that either the integrated powerbank assembly 10 and/or the non-integrated powerbank station 110 may be purchased directly from an automobile manufacturer, including as an add-on option before the vehicle is produced, for example, while making a custom manufacturing selection. It is also contemplated that individuals will be able to purchase individual portable units 21/121 directly from the manufacturer, and/or that these units 21/121 may be associated with a particular vehicle make or model. For example, each individual portable unit 21/121 may function as the vehicle's key. As a further example, each individual portable unit 21/121 may also comprise memory capabilities configured to track and/or receive vehicle specific data, which may in turn consolidate various functionalities for the user. As a result, the foregoing features may provide for an enhanced experience and may bolster the relationship between the manufacturer and the user.

Yet additional features of the present invention comprise providing a portable power unit 21/121 configured to enable the display of video and/or audio content on a screen of a mobile device. For example, and with reference to at least the illustrative embodiments of FIGS. 7-8, a portable power unit 21/121 according to the present invention may be operatively structured for insertion onto a mobile device case 26. Additionally, a portable power unit 21/121 according to the present invention may be operatively formed or otherwise enclosed within the mobile device case itself 26. As such, it is contemplated that the portable power unit 21/121 may be disposed in sufficient proximity to a mobile device capable of supporting a contactless communications protocol. That is, the portable power unit 21/121 may comprise a wireless communication component that can enable a one way or a two-way communication protocol with the mobile device, for example, to automatically display video and/or audio content on a screen of the mobile device. Alternatively, the wireless communication component of the portable power unit 21/121 may be configured to direct the user to a website, i.e., via a web browser of the mobile device, to display the video and/or audio content. By way of example, such reproduceable video and/or audio content may comprise promotional content or advertisements.

Also as an example, the portable power unit 21/121 may be provided with a radio frequency identification (“RFID”) and/or a near field communication (“NFC”) component, e.g., transponder, card, tag, chip, microchip, etc. As such, when portable power unit 21/121 is disposed within sufficient proximity to the mobile device, e.g., with support for RFID and/or NFC, a one-way or two-way communication protocol may be enabled. As a further example, the RFID component may comprise a passive device, e.g., that does not have its own power source, and which may be powered by a field generated by a reader, e.g., an antenna of the mobile device, and that may be configured to modulate the field generated by the reader thereby prompting or otherwise enabling the video and/or audio content on to the screen of the device. Alternatively, the internal battery of the portable power unit 21/121 may act as a power source to the wireless communication component, which may be disposed on or inside of the housing 22.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents

1. A powerbank assembly at least partially integrated into a vehicle, the powerbank assembly comprising:
at least one portable power unit comprising a housing and a rechargeable battery disposed therein,
a charging assembly comprising:
a receptacle disposed within a component of the interior of the vehicle, the receptacle comprising a socket configuration, and
a power source operatively connected to the receptacle, the receptacle and the power source cooperatively configured to replenish a charge of the rechargeable battery of the at least one portable power unit,
the housing of the at least portable power unit and the receptacle collectively configured and dimensioned for the housing of the at least one power unit to be inserted and removed from the receptacle, and
the housing of the at least one portable power unit and the receptacle collectively disposable into and out of a charging position and a released position.

2. The powerbank assembly as recited in claim 1 wherein the power source comprises a rechargeable battery operatively connected to the electric system of the vehicle; the receptacle being operatively connected to the power source and structured to replenish a charge of the rechargeable battery of the at least one power unit.

3. The powerbank assembly as recited in claim 1 wherein the power source is the electric system of the vehicle; the receptacle being operatively connected to the power source and structured to replenish a charge of the rechargeable battery of the at least one power unit.

4. The powerbank assembly as recited in claim 1 wherein the housing of the at least one portable power unit is inserted into the receptacle and the receptacle is structured to replenish a charge of the rechargeable battery of the at least one power unit when in the charging position; the at least one portable power unit is removed from the receptacle when in the released position.

5. The powerbank assembly as recited in claim 1 wherein the receptacle comprises a spring mechanism configured to retain the housing of the at least one portable power unit when it is pushed into the receptacle and to release the housing of the at least one portable power unit when it is pushed into the receptacle while retained within the receptacle.

6. The powerbank assembly as recited in claim 1 wherein the charging assembly further comprises a first group of charging ports disposed on the at least one portable power unit and a second group of charging ports disposed on the receptacle and operatively configured with the electric system of the vehicle; the first group of charging ports and the second group of charging ports being collectively configured to replenish a charge of the rechargeable battery of the at least one power unit when in the charging position.

7. The powerbank assembly as recited in claim 1 wherein the at least one portable power unit is configured to be removably attached on a mobile device case or is integrally formed within a mobile device case.

8. The powerbank assembly as recited in claim 1 wherein the at least one portable power unit comprises a wireless communication component disposed on the housing; the wireless communication component configured to enable a communication protocol with a mobile device when the at least one portable power unit is adjacently disposed to the mobile device.

9. The powerbank assembly as recited in claim 8 wherein the wireless communication component is configured to display an audiovisual advertisement content on a screen of the mobile device when the at least one portable power unit is adjacently disposed to the mobile device.

10. The powerbank assembly as recited in claim 9 wherein the wireless communication component comprises an RFID transmitter or an NFC transmitter operatively structured with a corresponding RFID receiver or an NFC receiver of the mobile device to enable a data communication protocol therebetween.

11. A portable powerbank assembly configured for use with a vehicle, the portable powerbank station comprising:
at least one portable power unit comprising a case and a rechargeable battery disposed therein,
a casing configured for a removable attachment to the back of a seat or the back of a headrest of the vehicle,
a charging assembly disposed inside the casing, the charging assembly comprising:
at least one receptacle disposed on the casing, the at least one receptacle comprising a socket configuration,
a power source comprising an internal rechargeable battery and operatively connected to the at least one receptacle, the at least one receptacle and the power source cooperatively configured to provide a charge to the rechargeable battery of the at least one portable power unit,
the housing of the at least one portable power unit configured and dimensioned for insertion within the receptacle, and
the housing of the at least one portable power unit and the at least one receptacle collectively disposable into and out of a charging position and a released position.

12. The powerbank assembly as recited in claim 11 wherein the at least one receptacle and the housing of the at least portable power unit are collectively configured and dimensioned for the housing of the at least one power unit to be inserted and removed from the at least one receptacle.

13. The powerbank assembly as recited in claim 12 wherein the housing of the at least one portable power unit is inserted into the at least one receptacle and the at least one receptacle is structured to replenish a charge of the rechargeable battery of the at least one power unit when in the charging position; the housing of the at least one portable power unit is removed from the at least one receptacle when in the released position.

14. The portable powerbank assembly as recited in claim 11 wherein the charging assembly further comprises a first group of charging ports disposed on the at least one portable power unit and a second group of charging ports disposed on the at least one receptacle and operatively configured with the electric system of the vehicle; the first group of charging ports and the second group of charging ports being collectively configured to replenish a charge of the rechargeable battery of the at least one power unit when in the charging position.

15. The powerbank assembly as recited in claim 11 wherein the at least one portable power unit comprises a wireless communication component disposed on the housing; the wireless communication component configured to enable a communication protocol with a mobile device when the at least one portable power unit is adjacently disposed to the mobile device.

16. The powerbank assembly as recited in claim 15 wherein the wireless communication component is configured to display an audiovisual advertisement content on a screen of the mobile device when the at least one portable power unit is adjacently disposed to the mobile device.

17. The powerbank assembly as recited in claim 16 wherein the wireless communication component comprises an RFID transmitter or an NFC transmitter operatively structured with a corresponding RFID receiver or an NFC receiver of the mobile device to enable a data communication protocol therebetween.

18. The portable powerbank assembly as recited in claim 11 further comprising a processor disposed within the casing and operatively configured with a screen disposed on the casing; the processor operatively configured with executable code to display a plurality of user-selectable options on the screen.

19. The portable powerbank assembly as recited in claim 18 wherein at least one of the plurality of user-selectable options displayed on the screen comprises an option to purchase a replenishment charge of at least one existing portable power unit by making a payment and inserting the at least one existing portable power unit into the at least one socket for a predetermined time period.

20. The portable powerbank assembly as recited in claim 18 wherein at least one of the plurality of user-selectable options displayed on the screen comprises an option to swap a least one existing portable power unit with either at least one used and charged portable power unit or at least one new and charged portable power unit.

21. The portable powerbank assembly as recited in claim 18 wherein at least one of the plurality of user-selectable options displayed on the screen comprises an option to purchase either at least one used and charged portable power unit or at least one new and charged portable power unit.

22. A portable powerbank assembly configured for use with a vehicle, the portable powerbank station comprising:
at least one portable power unit comprising a case and a rechargeable battery disposed therein,
a casing configured for a removable attachment to the back of a seat or the back of a headrest of the vehicle,
a screen disposed on the casing,
a charging assembly disposed inside the casing, the charging assembly comprising:
at least one receptacle disposed on the casing, the at least one receptacle comprising a socket configuration,
a power source comprising an internal rechargeable battery and operatively connected to the at least one receptacle, the at least one receptacle and the power source cooperatively configured to provide a charge to the rechargeable battery of the at least one portable power unit,
a processor disposed within the casing and operatively configured with the screen; the processor operatively configured with executable code to display a plurality of user-selectable options on the screen;
the housing of the at least one portable power unit and the at least one receptacle configured and dimensioned for insertion and removal of the housing of the at least one portable power unit within the receptacle, and
the housing of the at least one portable power unit and the at least one receptacle collectively disposable into and out of a charging position and a released position.

23. The portable powerbank assembly as recited in claim 22 wherein the processor is operatively configured with a server and a remote device to allow a user of the remote device to display a plurality of user-selectable options on a screen of the remote device.

24. The portable powerbank assembly as recited in claim 23 wherein at least one of the plurality of user-selectable options comprises an option to place a request for the delivery of the at least one portable power unit; the at least one portable power unit comprises a new and charged portable power unit or a used and at least partially charged portable power unit.
